(19) United States
(12) Patent Application Publication
(10) Pub. No.: US 2004/0064989 A1
(43) Pub. Date: Apr. 8, 2004

(54) Phosphorescent light emitting beverage container

(76) Inventors: Trevor Nottage, Nassau (BS); Davinia Louise Bain, Nassau (BS)

Correspondence Address: LERNER AND GREENBERG, P.A., POST OFFICE BOX 2480, HOLLYWOOD, FL, 33022-2480, US

(21) Appl. No.: 10/612,627

(22) Filed: Jul. 2, 2003

Related U.S. Application Data
(60) Provisional application No. 60/392,852, filed on Jul. 2, 2002.

(51) Int. Cl. G09F 3/00; G09F 13/20

(52) U.S. Cl. 40/542; 40/306

(57) ABSTRACT

Any beverage container having phosphorescent luminosity on the exterior surface as a light source for reading and or decorative purposes in the absence of any other light source. The beverage containers can include cans, bottles (plastic or glass), cartons, ‘squeeze-up’ plastic containers or any other beverage container. The exterior surface of the beverage container includes a phosphorescent luminescent coating thereon for providing luminosity for reading or decorative purposes in the absence of any other light source. The phosphorescent luminescent coating may exist in the form of paint directly applied to the container, and adhesive coat or sheet applied to the container, a plastic sleeve partially or completely covering the container, a material (egg plastic or bottle) made with the phosphorescent pigments in its formation and any other means of application.

### CROSS-REFERENCE TO RELATED APPLICATION

This application claims the benefit under 35 U.S.C. § 119(e) of copending provisional application No. 60/392,852, filed Jul. 2, 2002.

### BACKGROUND OF THE INVENTION

1. Field of the Invention

This invention relates to a beverage container having phosphorescent luminosity for the purpose of reading and or decoration in the absence of any other source of light. More practically, the luminosity could be emitted from any lettering, marking, partial covering or complete covering on the beverage container from which the luminosity allows for reading (as do regular lamps, candles or flashlights) or to be used as a decorative ornament.

2. Background of the Invention

Beverage containers are everyday products used in most places around the world. The intent is to use these everyday products as portals of light. In many parts of the world, light source is a problem. In these same rural areas literacy tends to be low partially because of the lack of visibility after the sunset. Phosphorescent light emitting from a beverage container, at present, can allow for up to an hour of good reading light and can be recharged simply by resting in the sun for 5 minutes or more (or it can be charged by any other light source). The recharging ability of this light source allows it to be useful infinitely.

In these rural areas and in areas around the world where after-dark light source is not a challenge, this invention is a great source of decorative fun. It can be used as lanterns at parties, driveway markings Christmas tree ornaments or in whichever decorative manner the owner wishes.

3. Description of the Related Art

Luminescent articles and devices such as indicators, containers, bottles, lampshades, and labels have been disclosed in the prior art. For example, U.S. Pat. No. 4,708,817 to DUDNICK discloses a container having a latent message on the container's surface is coated with a luminescent, phosphorescent and/or fluorescent material, such that the warning message glows and is clearly discernible in the dark. This prior art patent does not disclose or teach a beverage container having luminosity, being a luminescent coating thereon or luminescent pigment in its material, for reading or decorative purposes in the absence of any other light source.

U.S. Pat. No. 4,943,896 to JOHNSON discloses a method of producing improved infant care articles, such as baby bottle assemblies, characterized by the inclusion of a non-toxic, non-irritating phosphorescent material with the material of construction of components of the infant care articles so that such components phosphorescently emit light visible in the darkened environment, allowing the location and position of the articles to be readily determined without the need for an additional light source. This prior art patent does not disclose or teach a beverage container having luminosity, being a luminescent coating thereon or luminescent pigment in its material, for reading or decorative purposes in the absence of any other light source.

U.S. Pat. No. 5,172,937 to SACHETTI discloses structures, such as labels on beer bottles having fluorescent and phosphorescent materials that emit and reflect light to provide a sense of identity to the beer bottle. The label is in the form of a blanket that has a protective grid of phosphorescent material thereon, such that when the phosphorescent material is exposed to light and placed in a dark environment the beer bottle label emits light for a period of time. The protective grid is a pattern of intersecting ribbons of phosphorescent material anchored to and covering substantially on surface of the label. The protective grid provides a visual light shield that creates an image of identification for that label. This prior art patent does not disclose or teach a beverage container having luminosity, being a luminescent coating thereon or luminescent pigment in its material, for reading or decorative purposes in the absence of any other light source.

U.S. Pat. No. 5,654,552 to TOOMBS discloses a glow-in-the-dark lampshade that includes a glow-in-the-dark region with a first side disposed toward a light source so that the light source illuminates the first side and with a second side disposed away from the light source. The glow-in-the-dark region includes a glow0in-the-dark substance that stores energy from illumination and that responds to the stored energy by emitting light in the visible range. This prior art patent does not disclose or teach a beverage container having luminosity, being a luminescent coating thereon or luminescent pigment in its material, for reading or decorative purposes in the absence of any other light source.

U.S. Pat. No. 5,752,761 to PIETRUCZYNIK discloses a high visibility flashlight body having a luminescent outer surface on the main body and closure cap. The outer surface includes a luminescent colorant composition in the based material, being distributed throughout the thickness of the main body. This prior art patent does not disclose or teach a beverage container having luminosity, being a luminescent coating thereon or luminescent pigment in its material, for reading or decorative purposes in the absence of any other light source.

None of these prior art patents disclose or teach a beverage container having luminosity, being a luminescent coating thereon or luminescent pigment in its material, for reading or decorative purposes in the absence of any other light source.

### SUMMARY OF THE INVENTION

Accordingly, it is an object of the present invention to provide a beverage container having luminosity, being a luminescent coating thereon or luminescent pigment in its material, for reading or decorative purposes in the absence of any other light source.

Accordingly, an advantage of this present invention is that it provides a limited but useful amount of reading light (in the absence of any other light) to less developed areas, where reading light at night is a challenge, for marginally more than what one might pay for a beverage.

Another advantage of this present invention is that is provides a means with which developing and more developed countries can relatively inexpensively assist less developed nations with reading disabilities caused by inadequate light sources.

Another advantage of this invention is that provides a decorative utility for individuals looking to decorate areas or objects in the absence of any other light, for example, one can use the full or empty containers to decorate a Christmas tree or a beach party scene.

Other features which are considered as characteristic for the invention are set forth in the appended claims.

Although the invention is illustrated and described herein as embodied in a phosphorescent light emitting beverage container, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

Further objects, features and advantages of the present invention will become apparent upon the consideration of the following description of the attached drawings, wherein:

FIG. 1 is a beverage carton with phosphorescent ink/paint printed on the exterior surface of the container that illuminates in the absence of any other light.

FIG. 2 is a beverage can with phosphorescent ink/paint printed on the exterior surface of the container that illuminates in the absence of any other light.

FIG. 3 is a plastic beverage bottle made with phosphorescent pigments that illuminates in the absence of any other light.

FIG. 4 is a glass beverage bottle made with phosphorescent pigments that illuminates in the absence of any other light.

FIG. 5 is a ‘stand-up pouch’ beverage container with phosphorescent ink/paint printed on the exterior surface of the container that illuminates in the absence of any other light.

FIGS. 6 and 7 are beverage cartons with phosphorescent ink/paint printed on the exterior surface of the container that illuminates in the absence of any other light.

FIG. 8 is a plastic sleeve made with phosphorescent pigments and or coated with phosphorescent ink (partially or entirely) for the purpose of rapping around the exterior of any beverage container and illuminates in the absence of any other light.

FIG. 9 is an adhesive label made with phosphorescent pigments and or coated with phosphorescent ink (partially or entirely) for the purpose of adhering to the exterior of a beverage container and illuminates in the absence of any other light.

### DESCRIPTION OF THE PREFERRED EMBODIMENTS

This invention is a composition of existing products. The articles used are as follows:

1 Phosphorescent pigments. One example of phosphorescent pigments which have been employed to form the invention is sold under the trade mark Super Phosphorescent by Shannon Luminous Material Inc. These pigments have an initial brightness equivalent to 3 lit candles;

2 Phosphorescent adhesive sheets. One example of phosphorescent adhesive sheets which have been employed to form the invention is sold under the trademark Phosphorescent Tape by Shannon Luminous Materials Inc.

3 Plastic shrink sleeves, like those manufactured by Sleeve Co. under the trademark of Shrink Labels; and

4 Beverage containers

4i aluminum cans, like those manufactured by Metal Container Corporation;

4ii glass bottles, like those manufactured by California Glass Company under the trademark of 12 oz Heritage;

4iii plastic bottles, like those manufactured by the BALL Corporation under the trademark of PET Plastic containers (polyethylene terephthalate);

4iv paper carton, like those supplied by ELOPAK under the trademark of Pure-Pak long life containers;

4v stand-up pouch containers, like those supplied by T.H.E.M. under the trademark of Stand-Up Pouch; and

4vi any other beverage container.

In order to assemble the invention using a beverage aluminum can 4i shown in FIG. 2, one can add the phosphorescent pigment color(s) 1 of choice to the existing printing process for direct application to the exterior of the can as outlined in the detailed description of the preferred embodiment of Pat. No. 6,501,046. Alternatively, one can apply phosphorescent adhesive sheets 2 shown in FIG. 9 to the exterior of the can in whatever shape, size or lettering desired. Alternatively, one can add an adhesive label, which has phosphorescent pigments 1 as shown in FIG. 9 used in the ink with which the label is printed and subsequently add to the exterior of the can.

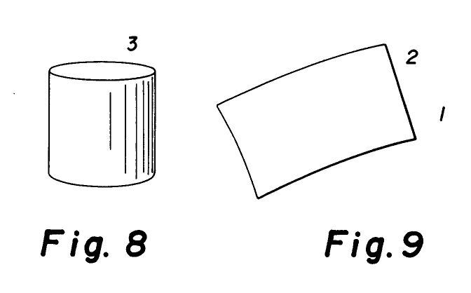

In order to assemble the invention using plastic bottles 4iii shown in FIG. 3 or glass bottles 4ii shown in FIG. 4, one can add the phosphorescent pigments color(s) 1 of choice to the plastic or glass while it is in a liquid state, before molding (according to process for making a plastic or glass bottle as described in the detailed description of U.S. Pat. Nos. D469,288 and D463,288 respectively. The result is a translucent or tinted plastic or glass bottle that has the phosphorescent pigments mixed within its particles. Alternatively, one can cover the glass or plastic bottle with a shrink sleeve 3 shown in FIG. 8 that was made with the phosphorescent pigments 1 or printed thereon (using the process as outlined in US Pat. Application No. 20020119294, paragraphs 23-25 of the detailed description of the preferred embodiment) with phosphorescent pigments 1 mixed in the ink. Alternatively, one can add an adhesive label, which has phosphorescent pigments 1 as shown in FIG. 9 used in the ink with which the label is printed and applied to the exterior of the glass 4ii shown in FIG. 4 or plastic bottle 4iii shown in FIG. 3.

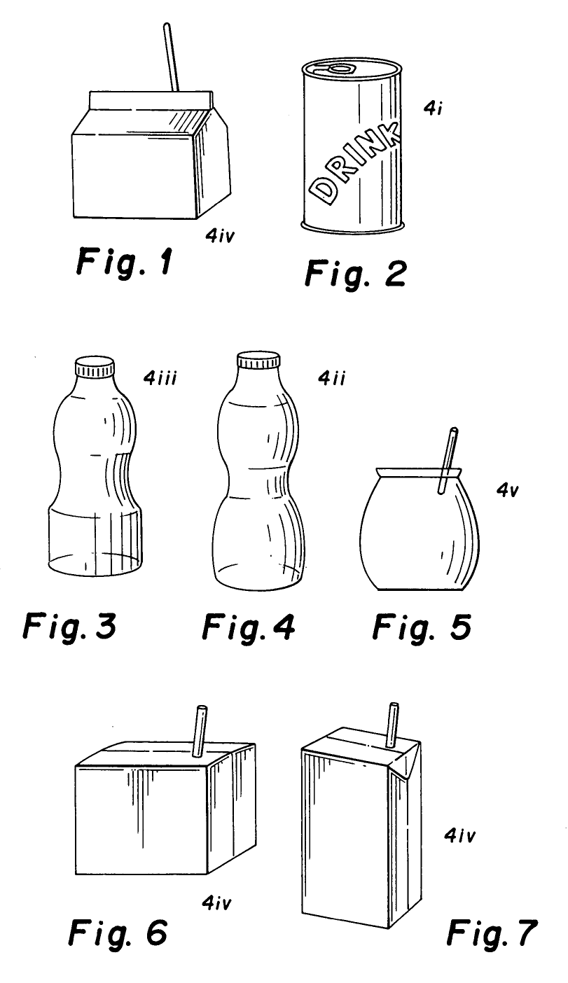

In order to assemble the invention using beverage cartons 4iv shown in FIGS. 1, 6 and 7, one can add the phosphorescent pigment color(s) 1 of choice to the existing printing ink and process for direct application to the exterior of the carton. Alternatively, one can apply phosphorescent adhesive sheets 2 shown in FIG. 9 to the exterior of the carton in whatever shape, size or lettering desired. Alternatively, one can add an adhesive label, which has phosphorescent pigments 1 as shown in FIG. 9 used in the ink with which the label is printed and applied to the exterior of the carton.

In order to assemble the invention using beverage stand-up pouch 4v containers shown in FIG. 5, one can add the phosphorescent pigment color(s) 1 of choice to the existing printing process for direct application to the exterior of the container. Alternatively, one can apply phosphorescent adhesive sheets 2 shown in FIG. 9 to the exterior of the container in whatever shape, size or lettering desired. Alternatively, one can add an adhesive label, which has phosphorescent pigments 1 as shown in FIG. 9 used in the ink with which the label is printed to the exterior of the container.

In order to assemble the invention using any other beverage container 4vi, one can mix the phosphorescent pigments 1 with the particles of the container providing that the container is translucent. Alternatively, once can apply phosphorescent adhesive sheets 2 shown in FIG. 9 to the exterior of the container in whatever shape, size or lettering desired. Alternatively, one can add an adhesive label, which has phosphorescent pigments 1 as shown in FIG. 9 used in the ink with which the label is printed to the exterior of the container.

We claim:

1. A beverage container, comprising a container body, and a source of luminescence associated with said container body for emitting light.

2. The beverage container according to claim 1, wherein said source of luminescence is a coating disposed on said container body.

3. The beverage container according to claim 1, wherein said container body is formed of a body material, and said source of luminescence is a luminescent pigment disposed in said body material.

4. The beverage container according to claim 1, further comprising indicia associated with said container body, said source of luminescence being disposed in said indicia.

5. The beverage container according to claim 4, wherein said indicia is lettering or graphics and said source of luminescence is a pigment in ink forming said lettering or graphics.

6. The beverage container according to claim 4, wherein said container body is formed of a body material, said indicia is lettering or graphics, and said source of luminescence is a pigment in ink forming said lettering or graphics and disposed within said body material.

7. The beverage container according to claim 4, wherein said indicia is lettering or graphics, and said source of luminescence is a pigment in ink forming said lettering or graphics and disposed on said body.

8. The beverage container according to claim 1, wherein said container body is formed of plastic.

9. The beverage container according to claim 1, wherein said container body is formed of glass.

10. The beverage container according to claim 1, wherein said container body is formed of paper.

11. The beverage container according to claim 1, wherein said container body is formed of metal.

12. The beverage container according to claim 1, which further comprises a label disposed on said container body, said label containing indicia having said source of luminescence.

13. The beverage container according to claim 12, wherein said indicia is lettering or graphics and said source of luminescence is a pigment in ink forming said lettering or graphics.

14. The beverage container according to claim 12, wherein said label is formed of a body material, said indicia is lettering or graphics, and said source of luminescence is a pigment in ink forming said lettering or graphics and disposed within said body material.

15. The beverage container according to claim 12, wherein said label is formed of a body material, said indicia is lettering or graphics, and said source of luminescence is a pigment in ink forming said lettering or graphics and disposed on said body material.

16. The beverage container according to claim 12, wherein said label is an adhesive label.

17. The beverage container according to claim 1, further comprising a sleeve disposed on said container body for maintaining a temperature of contents of said container body, said sleeve containing indicia having said source of luminescence.

18. The beverage container according to claim 17, wherein said indicia is lettering or graphics and said source of luminescence is a pigment in ink forming said lettering or graphics.

19. The beverage container according to claim 17, wherein said sleeve is formed of a body material, said indicia is lettering or graphics, and said source of luminescence is a pigment in ink forming said lettering or graphics and disposed within said body material.

20. The beverage container according to claim 17, wherein said sleeve is formed of a body material, said indicia is lettering or graphics, and said source of luminescence is a pigment in ink forming said lettering or graphics and disposed on said body material.

21. The beverage container according to claim 17, wherein said sleeve is formed of plastic.

22. The beverage container according to claim 17, wherein said sleeve is formed of rubber.
